(19) United States
(12) Patent Application Publication
(10) Pub. No.: US 2018/0086364 A1
(43) Pub. Date: Mar. 29, 2018

(54) STEERING COLUMN FOR VEHICLE

(71) Applicant: MANDO CORPORATION, Pyeongtaek-si (KR)

(72) Inventor: Hyun Bi KWON, Yongin-si (KR)

(21) Appl. No.: 15/274,839

(22) Filed: Sep. 23, 2016

(51) Int. Cl. B62D 5/04; B62D 1/16

(52) U.S. Cl. CPC B62D 5/0409; B62D 5/0463; F16H 57/0025; B62D 1/16; B62D 5/0481

(57) ABSTRACT

The present invention provides a steering column for a vehicle that includes: an input shaft having a first end connected to a steering shaft, a torque sensor being attached to an outer peripheral surface of the input shaft; an output shaft having a first end connected to a second end of the input shaft and a second end connected to a pinion shaft, a worm wheel being coupled to an outer peripheral surface of the output shaft; a torsion bar having a first end and a second end that are coupled to an inner peripheral surface of the input shaft and an inner peripheral surface of the output shaft, respectively; and a support member coupled to an outer peripheral surface of the second end of the input shaft and an inner peripheral surface of the first end of the output shaft.

### BACKGROUND OF THE INVENTION

### 1. Field of the Invention

The present invention relates to a steering column for a vehicle. More specifically, the present invention relates to a steering column for a vehicle, which may be reduced in the entire volume and weight while ensuring that an input shaft and an output shaft are not twisted or do not break away from a regular position at a portion where a worm shaft and a worm wheel that provide a steering assist power from a motor, a torque sensor, and so on are coupled.

### 2. Description of the Prior Art

In general, a steering apparatus for vehicle uses a power steering system as an auxiliary power mechanism in order to relive the force to be applied by a driver. Power steering systems are classified into a hydraulic power steering system, which uses a hydraulic pressure for assisting a steering force by operating a hydraulic pump by using the power of an engine, and an electric power steering system, which uses an electric motor.

The hydraulic power steering system has a structure in which the rotation of a steering wheel is sensed and a torque is received from an engine to operate a hydraulic pump, and the hydraulic pressure is sent to a driving unit, such as a cylinder, that is configured in a rack bar or a steering shaft, thereby assisting a driver's steering force.

The electric power steering system has a structure in which the rotation of a steering wheel is sensed to operate a motor that is installed in a rack or a steering shaft to assist a rotational movement, thereby causing the steering device to be smoothly operated. The electric power steering system is generally classified into a rack drive type (R-EPS) and a column drive type (C-EPS).

Hereinafter, descriptions will be made with reference to an electric power steering system.

FIG. 1 is a schematic view illustrating a conventional steering apparatus for vehicle, and FIG. 2 is a partial sectional view illustrating a conventional steering column for a vehicle.

As illustrated in the drawings, the conventional steering apparatus for vehicle includes a steering system 100 that is continued from a steering wheel 101 to opposite vehicle wheels 108, and an auxiliary power mechanism 120 that provides a steering assist power to the steering system 100.

The steering system 100 includes a steering shaft 102 that is connected, at one side, to the steering wheel 101 to be rotated together with the steering wheel 101, and, at the other side, is connected to a pinion shaft 104 via a pair of universal joints 103.

In addition, the pinion shaft 104 is connected to a rack bar through a rack and pinion mechanism 105, and the opposite ends of the rack bar are connected to vehicle wheels 108 through tie rods 106 and knuckle arms 107. The rack and pinion mechanism 105 is formed as a pinion gear 111, which is formed on a pinion shaft 104, and a rack gear 112, which is formed on one side of the outer peripheral surface of the rack bar, are engaged with each other. Thus, when a driver operates the steering wheel 101, a torque is generated in the steering system 100, and the vehicle wheels 108 are steered by the torque transferred via the rack and pinion mechanism 105 and the tie rods 106.

An auxiliary power mechanism 120 includes: a torque sensor 125 configured to sense a torque that is applied to the steering wheel 101 by the driver and to output an electric signal that is proportional to the sensed torque; an Electronic Control Unit (ECU) 123 configured to generate a control signal based on the electric signal transferred from the torque sensor 125; a motor 130 configured to generate an auxiliary power based on the control signal transferred from the ECU 123; and a reducer 140 including a worm wheel 141 and a worm shaft 143 to transmit the auxiliary power generated by the motor 130 to the steering shaft 102.

In addition, the steering shaft includes an input shaft 215, a lower steering shaft 210 coupled to the input shaft 215 by a pin 225, and an upper steering shaft 205 coupled to the lower steering shaft 210, and the shafts are coupled to each other to be aligned to the same central axis. The upper steering wheel 205 is connected to the steering wheel (not illustrated), and the input shaft 215 is press-fitted to the output shaft 220 to transfer the steering power of the steering wheel.

The lower end of the lower steering shaft 210 is inserted into the input shaft 215 and is coupled to the input shaft 215 and a torsion bar 230 via the pin 225, and the upper end of the lower steering shaft 210 is coupled with the upper steering shaft 205 by making a serrations 235, which is formed on the outer peripheral surface of the upper end, mate with a serration 235, which is formed on the inner peripheral surface of the upper steering shaft 205, and molding plastic to the serrations 235 such that the serrations 235 are coupled to each other.

The conventional steering column for a vehicle described above has a problem in that the input shaft and the output shaft are twisted or deviated from a regular position in an area where the worm shaft and the worm wheel that provide a steering assist power from the motor, the torque sensor, and the like are coupled, and as a result, a correct steering assist power cannot be provided.

In addition, due to the structure of the steering column, because it is difficult to change the position of the auxiliary power mechanism or the like that is coupled to the steering column, and it is also difficult to reduce the volume of the steering column, there is a necessity for reducing the volume and weight of the steering column.

### SUMMARY OF THE INVENTION

More specifically, the present invention relates to a steering column for a vehicle, which may be reduced in the entire volume and weight while ensuring that an input shaft and an output shaft are not twisted or do not break away from a regular position at a portion where a worm shaft and a worm wheel that provide a steering assist power from a motor, a torque sensor, and so on, are coupled.

Further, the aspect of the present invention is not limited thereto, and other unmentioned aspects of the present invention may be clearly appreciated by those skilled in the art from the following descriptions.

In order to achieve the object, the present invention provides a steering column for a vehicle that includes: an input shaft having a first end connected to a steering shaft, a torque sensor being attached to an outer peripheral surface of the input shaft; an output shaft having a first end connected to a second end of the input shaft and a second end connected to a pinion shaft, a worm wheel being coupled to an outer peripheral surface of the output shaft; a torsion bar having a first end and a second end that are coupled to an inner peripheral surface of the input shaft and an inner peripheral surface of the output shaft, respectively; and a support member coupled to an outer peripheral surface of the second end of the input shaft and an inner peripheral surface of the first end of the output shaft.

According to the present invention as described above, in a steering column for a vehicle, it is possible to reduce the entire volume and weight while ensuring that the input shaft and the output shaft are not twisted or do not break away from a regular position at a portion where a worm shaft and a worm wheel that provide a steering assist power from a motor, a torque sensor, and so on, are coupled.

### BRIEF DESCRIPTION OF THE DRAWINGS

The above and other objects, features, and advantages of the present invention will be more apparent from the following detailed description taken in conjunction with the accompanying drawings, in which:

FIG. 1 is a schematic view illustrating a conventional steering apparatus for vehicle;

FIG. 2 is a partial sectional view illustrating a conventional steering column for a vehicle;

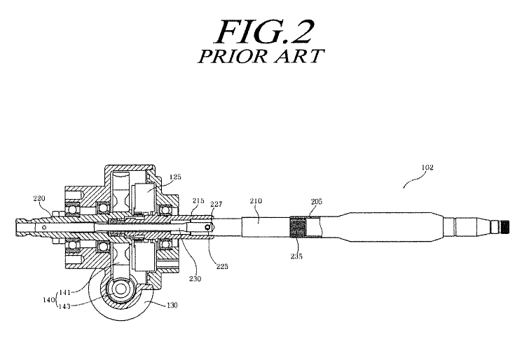

FIG. 3 is an exploded perspective view illustrating a portion of a steering column for a vehicle according to the present invention;

FIG. 4 is a partial sectional view illustrating a portion of a steering column for a vehicle according to the present invention;

FIG. 5 is a partial sectional view illustrating a portion of a steering column for a vehicle according to the present invention;

FIG. 6 is a perspective view illustrating a portion of a steering column for a vehicle according to the present invention; and

FIG. 7 is an enlarged sectional view illustrating a portion in FIG. 4 in an enlarged scale.

### DETAILED DESCRIPTION OF THE EXEMPLARY EMBODIMENTS

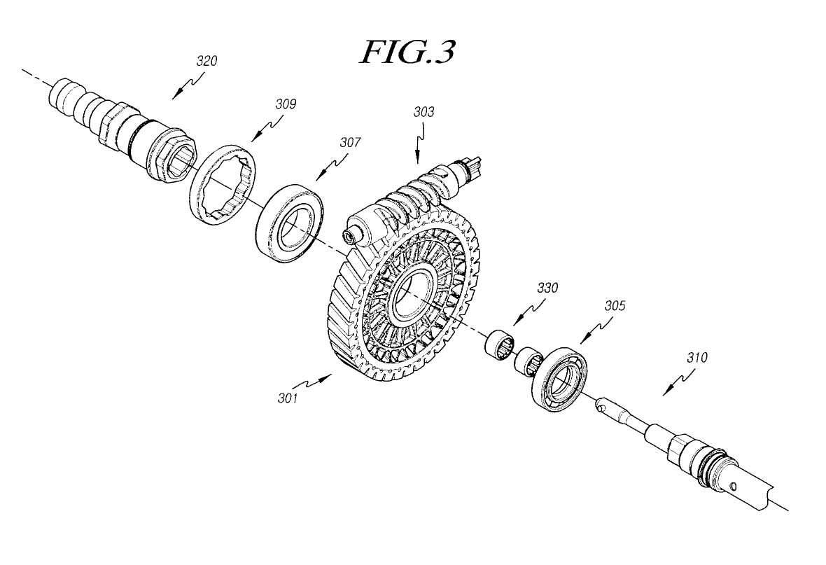

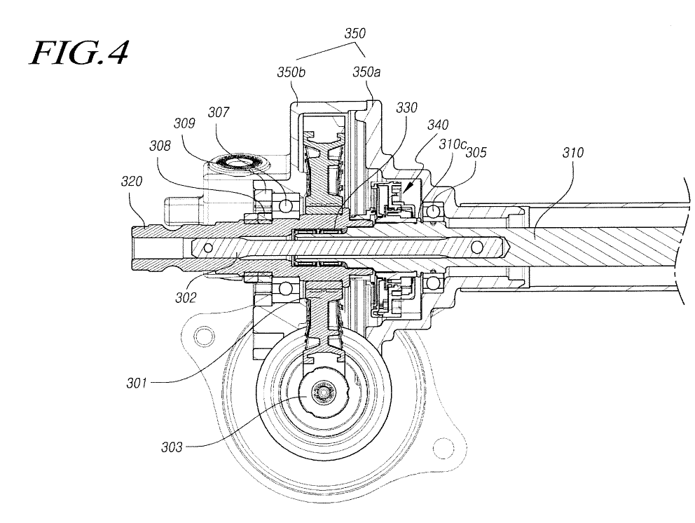

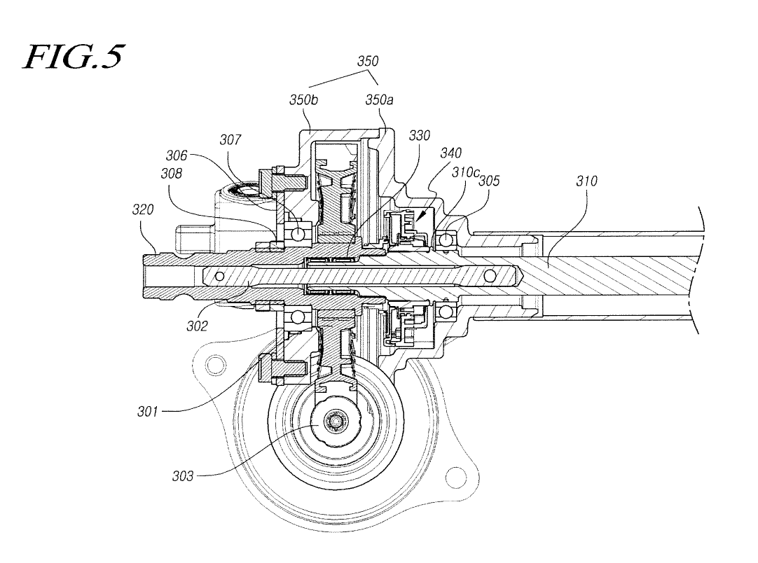

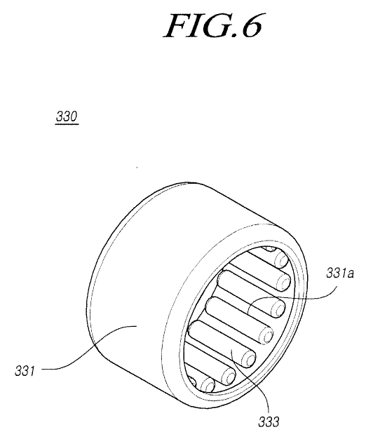

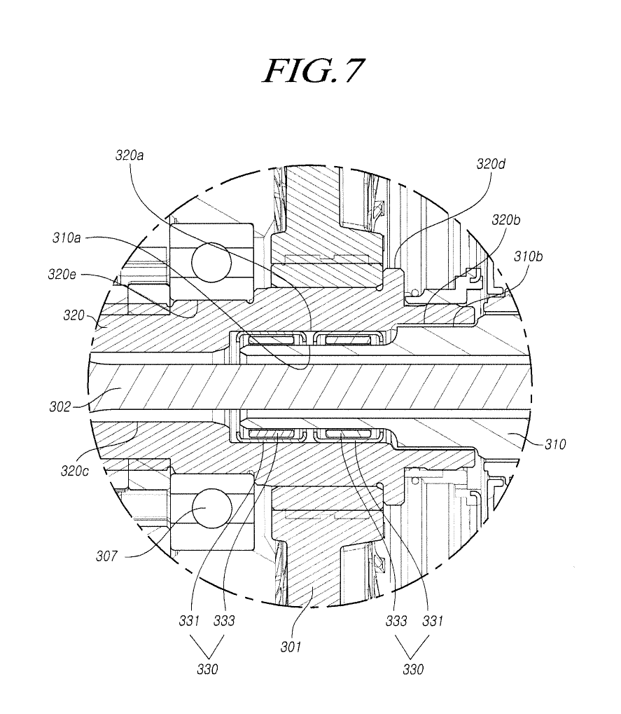

FIG. 3 is an exploded perspective view illustrating a portion of a steering column for a vehicle according to the present invention, FIG. 4 is a partial sectional view illustrating a portion of a steering column for a vehicle according to the present invention, and FIG. 5 is a partial sectional view illustrating a portion of a steering column for a vehicle according to the present invention. FIG. 6 is a perspective view illustrating a portion of a steering column for a vehicle according to the present invention, and FIG. 7 is an enlarged sectional view illustrating a portion in FIG. 4 in an enlarged scale.

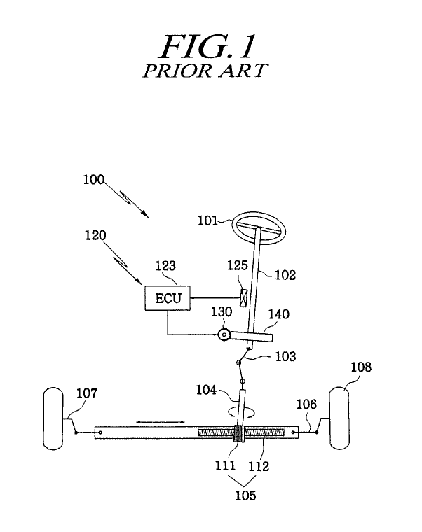

As illustrated in the drawings, a steering column for a vehicle according to the present invention includes: an input shaft 310 having a first end connected to a steering shaft (see “102” in FIG. 1), in which a torque sensor 340 is attached to an outer peripheral surface of the input shaft 310; an output shaft 320 having a first end connected to a second end of the input shaft 310 and a second end connected to a pinion shaft (see “104” in FIG. 1), in which a worm wheel 301 is coupled to an outer peripheral surface of the output shaft 320; a torsion bar 302 having a first end and a second end that are coupled to an inner peripheral surface of the input shaft 310 and an inner peripheral surface of the output shaft 320, respectively; and a support member 330 coupled to an outer peripheral surface of the second end of the input shaft 310 and an inner peripheral surface of the first end of the output shaft 320.

The torque sensor 340 is coupled to the outer peripheral surface of the input shaft 310 connected to the steering shaft so as to measure a torque generated when the driver operates the steering wheel, and transmits a steering assist force to the output shaft 320 through the auxiliary power mechanism.

Here, the auxiliary power mechanism includes: a torque sensor 340 configured to sense a torque when the steering wheel is operated by the driver and to output an electric signal that is proportional to the sensed torque; an electronic control unit (not illustrated) configured to generate a control signal based on the electric signal transferred from the torque sensor 340; a motor configured to generate an auxiliary power based on the control signal transferred from the electronic control unit; and a worm shaft 303 and a worm wheel 301 configured to transmit the auxiliary power generated by the motor to the output shaft 320.

The first end of the output shaft 320 is connected to the second end of the input shaft 310 and the worm wheel 301 is coupled to the outer peripheral surface of the output shaft 320. The second end of the output shaft 320 is connected to the pinion shaft via a universal joint, and a first end and a second end of the torsion bar 302 are coupled to the inner peripheral surfaces of the input shaft 310 and the output shaft 320, respectively.

In addition, in order to ensure that the input shaft 310 and the output shaft 320 can be smoothly operated coaxially, a support member 330 may be interposed between the outer peripheral surface of the second end of the input shaft 310 and the inner peripheral surface of the first end of the output shaft 320.

Further, the first end of the output shaft 320 includes a protrusion 320b formed to axially protrude, and the input shaft 310 includes a first small diameter portion 310b that is formed as a diameter is reduced in the outer peripheral surface on which the torque sensor 340 is seated, so that the protrusion 320b of the output shaft 320 is coupled to an outer periphery side of the first small diameter portion 310b of the input shaft.

The input shaft 310 includes a second small diameter portion 310a that is formed as the diameter is reduced at a tip end of the first small diameter portion 310b, so that the support member 330 is coupled between the inner peripheral surface of the output shaft 320 and an outer peripheral surface of the second small diameter portion 310a.

In addition, the first end of the output shaft 320 includes an enlarged diameter portion 320a that is formed as the diameter is enlarged diametrically outward in an insertion hole 320c, into which the torsion bar 302 is inserted, so that the support member 330 may be coupled between an inner peripheral surface of the enlarged diameter portion 320a and the outer peripheral surface of the second small diameter portion 310a.

Meanwhile, the output shaft 320 includes a first step portion 320d that protrudes diametrically on an outer peripheral surface of a tip end of the protrusion 320b such that a side end of the worm wheel 301 is supported by and coupled to the first step portion 320d. Thus, the worm wheel 301 rotated by the worm shaft 303 is adapted to be capable of rotating the output shaft 320 without rolling or breaking away from a regular position.

In addition, the output shaft 320 is provided with a third small diameter portion 320e that is formed as the diameter is reduced at a tip end of the outer peripheral surface on which the worm wheel 301 is seated, in which a first bearing 307 is coupled to the outer peripheral surface of the third small diameter portion 320e, and, as illustrated in FIG. 4, an end of the inner ring of the first bearing 307 is coupled to be axially supported by a lock nut 308, and an end of an outer ring of the first bearing 307 is coupled to be axially supported by a lock screw 309 coupled to an inner peripheral surface of a housing 350.

In addition, as illustrated in FIG. 5, the first bearing 307 may be coupled in such a manner in which the end of the inner ring of the first ring 307 is coupled to be axially supported by the lock nut 308, and the end of the outer ring of the first bearing 307 is coupled to be axially supported by a support bracket 306 coupled to the outside of the housing 350.

Accordingly, the opposite ends of the first bearing 307 are rigidly supported axially by the step portion formed at one side of the third small diameter portion 320e, the lock nut 308, the lock screw 309, the support bracket 306, and the like, thereby supporting the output shaft 320 and the input shaft 310 coaxially without rolling or breaking away from the regular position.

In addition, the input shaft 310 includes a second step portion 310c that protrudes diametrically at a tip end of the outer peripheral surface on which the torque sensor 340 is seated, so that a side end of the torque sensor 340 is supported by and coupled to the second step portion 310c. Thus, the torque sensor 340 can precisely measure the torque of the input shaft 310 without rolling or breaking away from the regular position.

A second bearing 305 is supported at one side opposite to the second step portion 310c of the input shaft 310 and is coupled to the outer peripheral surface of the input shaft 310, and is supported on and coupled to an inner step portion of the first housing 350a at the other side. Thus, the second bearing 305 supports the output shaft 320 and the input shaft 310 coaxially without rolling or breaking away from the regular position.

The first bearing 307, the second bearing 305, the worm wheel 301, the torque sensor 340, and so on, which are coupled to the input shaft 310 and the output shaft 320 as described above, are embedded inside the housing 350, which is configured to be assembled by coupling a first housing 350a and a second housing 350b to each other.

Meanwhile, the support member 330 includes a cylindrical outer member 331 and rotary members 333 disposed on an inner peripheral surface of the outer member 331 to be spaced apart from each other in a circumferential direction and rotatably coupled to the inner peripheral surface of the outer member 331. Thus, the input shaft 310 can be supported on the output shaft 320 coaxially, and the rotation of the input shaft 310 can be supported in such a manner in which the input shaft 310 is not biased to any one side while being rotated. Occasionally, a cylindrical bush may be used.

In addition, by coupling the support member 330 to support a connection portion of the input shaft 310 and the output shaft 320 axially between the first bearing 307 and the second bearing 305, the coupling force between the input shaft 310 and the output shaft 320 and the coupling force between the first housing 350a and the second housing 350b are increased from the input shaft 310 to the output shaft 320. Thus, it is possible to reduce the entire volume and weight of the input shaft 310, the output shaft 320, the first housing 350a, and the second housing 350b without causing the input shaft 310, the output shaft 320, the first housing 350a, and the second housing 350b to be twisted or broken away from the regular position, even if a transferred power input from the motor and an impact force introduced from the outside are transferred.

Two or more support members 330 may be coupled at positions that are axially spaced apart from each other on the outer peripheral surface of the second small diameter portion 310a. In the present invention, it is illustrated that two support members 330 are coupled at the positions that are axially spaced apart from each other by a predetermined extent by way of an example. When two or more support members 330 are coupled as described above, the support force and coupling force at the position where the second end of the input shaft 310 and the first end of the output shaft 320 are coupled to each other.

According to the present invention having the structure and shape as described above, in a steering column for a vehicle, it is possible to reduce the entire volume and weight while ensuring that the input shaft and the output shaft are not twisted or do not break away from a regular position at a portion where a worm shaft and a worm wheel that provide a steering assist power from a motor, a torque sensor, and so on, are coupled.

1. A steering column for a vehicle comprising:
an input shaft having a first end connected to a steering shaft, a torque sensor being attached to an outer peripheral surface of the input shaft;
an output shaft having a first end connected to a second end of the input shaft and a second end connected to a pinion shaft, a worm wheel being coupled to an outer peripheral surface of the output shaft;
a torsion bar having a first end and a second end that are coupled to an inner peripheral surface of the input shaft and an inner peripheral surface of the output shaft, respectively; and
a support member coupled to an outer peripheral surface of the second end of the input shaft and an inner peripheral surface of the first end of the output shaft,
wherein the input shaft includes a first step portion that protrudes diametrically at a tip end of the outer peripheral surface on which the torque sensor is seated, so that a side end of the torque sensor is supported by and coupled to the first step portion, and
a first bearing is axially supported indirectly by a side surface of the first step portion of the input shaft and is coupled to the outer peripheral surface of the input shaft.

2. The steering column of claim 1, wherein the first end of the output shaft includes a protrusion formed to axially protrude, and the input shaft includes a first small diameter portion that is formed as a diameter is reduced in the outer peripheral surface on which the torque sensor is seated, so that the protrusion is coupled to an outer periphery side of the first small diameter portion, and
wherein the input shaft includes a second small diameter portion that is formed as the diameter is reduced at a tip end of the first small diameter portion, so that support member is coupled between the inner peripheral surface of the output shaft and an outer peripheral surface of the second small diameter portion.

3. The steering column of claim 2, wherein the first end of the output shaft includes an enlarged diameter portion that is formed as the diameter is enlarged diametrically outward in an insertion hole into which the torsion bar is inserted, so that the support member is coupled between an inner peripheral surface of the enlarged diameter portion and the outer peripheral surface of the second small diameter portion.

4. The steering column of claim 3, wherein the output shaft includes a second step portion that protrudes diametrically on an outer peripheral surface of a tip end of the protrusion such that a side end of the worm wheel is supported by and coupled to the second step portion, and a third small diameter portion is provided as the diameter is reduced at a tip end of the outer peripheral surface on which the worm wheel is seated, a second bearing being coupled to the outer peripheral surface of the third small diameter portion.

5. The steering column of claim 4, wherein an inner ring of the second bearing is coupled to be axially supported by a lock nut coupled to the outer peripheral surface of the output shaft.

6. The steering column of claim 5, wherein an outer ring of the second bearing is coupled to be axially supported by a lock screw coupled to an inner peripheral surface of a housing.

7. The steering column of claim 5, wherein an outer ring of the second bearing is coupled to be axially supported by a support bracket coupled to the outside of the housing.

8. (canceled)

9. The steering column of claim 3, wherein the support member includes a cylindrical outer member and rotary members disposed on an inner peripheral surface of the outer member to be spaced apart from each other in a circumferential direction and rotatably coupled to the inner peripheral surface of the outer member.

10. The steering column of claim 6, wherein two or more support members are coupled at positions that are axially spaced apart from each other on the outer peripheral surface of the second small diameter portion.
